(19) United States
(12) Patent Application Publication
(10) Pub. No.: US 2012/0279893 A1
(43) Pub. Date: Nov. 8, 2012

(54) Dispensing System and Package for Use Therewith

(76) Inventors: John Gelardi, Midlothian, VA (US); Laurel Thomas, Richmond, VA (US)

(21) Appl. No.: 13/098,786

(22) Filed: May 2, 2011

(51) Int. Cl. B65D 85/00; B65D 5/72; B65G 59/00; B65D 5/54

(52) U.S. Cl. 206/526; 229/122; 229/122.1; 221/31; 221/32; 221/1

(57) ABSTRACT

An improved dispersing system for dispensing products provided initially in a package that includes an activatable opening structure is disclosed. The dispensing system comprises a frame being configured to support the package of products and an opening tool associated with the frame. The opening tool engages with the activatable opening structure on the package to create an opening when the package is moved longitudinally along the frame of the dispensing system, thus allowing the products to be at least partially dispensed out of the package into the product display area of the frame through the opening formed on the rear panel or on an angular of the rear and side panels of the package.

### BACKGROUND

Point-of-sale (P.O.S.) or display units have continued to gain an increasing use in retail outlets because they present articles and products in an eye-catching and easily accessible manner. They also function as a storage area for products until the products are selected and taken away by customers. As products are removed, it is desirable for the shelf to present the next stored article being forwardly tilled for easy selection by customers. Some dispensers have sprung-biased mechanisms that push products forward. Some other known display devices use gravity feed mechanisms to cause products to flow to the forward-most sale position.

U.S. Pat. No. 5,396,997 discloses a dispensing device having upper and lower jar guides with a plurality of glass jar containers loaded on their sides through a container loading area. The dispenser racks successively feed one container at a time to the container dispensing area to thereby provide a self-feeding and self-facing storage, dispensing and display system. One drawback of such system is that loading of the dispensing device must be done manually and individually. Thus, it is labour intensive and time consuming to load such dispensing device at the retail stores.

U.S. Pat. No. 7,922,437 discloses an improved dispensing system for dispensing a plurality of products. The system includes: a dispersing frame having side walls, an upper support, and a product display area a carton package having a weakened severance line on it bottom panel; and an opening tool associated with the frame that severs the weakened severance line on the bottom panel of the carton when the carton is moved longitudinally along the frame, thereby allowing the products to be at least partially dispensed vertically downward from the bottom of the package into the product display area.

It is beneficial to have a dispensing system for dispensing a plurality of products wherein the packaged products may be dispensed from the carton in other directions, such as from the rear panel of the carton or from the angular angle of the back and side panels.

### SUMMARY

Disclosed is an improved system for dispensing products provided initially in a package. The package includes an activatable opening structure that forms an opening that allows products to at least partially exit the package along the longitudinal, loading axis.

In one aspect, the dispensing system includes (1) a frame being configured to support a package of products and including a front end section and a rear end section, the front end section being opposed from the rear end section along a longitudinal axis, a support deck extending at least partially between the front end section and the rear end section, and a product display area; and (2) an opening tool associated with the frame, the opening tool engaging an activatable opening structure on the package to create an opening when the package is moved longitudinally along the support deck, thus allowing at least one of the products to longitudinally move along the axis at least partially through the opening.

In another aspect, the dispensing system includes a frame being configured to support the package of products and an opening tool associated with the frame. The opening tool engages with the activatable opening structure on the package to create an opening when the package is moved longitudinally along the frame of the dispensing system, thus allowing the products to be at least partially dispensed out of the package into the product display area of the frame through the opening formed on the rear panel or on an angular of the rear and side panels of the package.

### BRIEF DESCRIPTION OF THE DRAWINGS

FIG. 1 illustrates one embodiment of the disclosed dispensing system, wherein the packaged products are dispensed from the rear panel of the package into the product display area;

FIG. 2 illustrates another embodiment of the disclosed dispensing system, wherein the packaged products are dispensed from the rear and side panels of the package;

FIGS. 3A to 3D illustrate perspective and side views of the disclosed dispensing system according to one embodiment, showing an engagement of the opening tool to the weakened severance line on the rear panel of the package;

FIG. 4A shows a side view of a dispensing system according to another embodiment of the disclosure;

FIG. 4B shows a perspective view of the dispensing system in FIG. 4A, showing an engagement between the opening tool of the dispensing system and the activatable opening structure of the package as the package is moved longitudinally along the frame toward the opening tool;

FIG. 4C shows a side view of the dispensing system in FIG. 4A, when the package is moved longitudinally along the support deck of the dispensing system toward the opening tool;

FIGS. 5A to 5C show side and perspective views of the dispensing system in FIG. 4C as the package is further moved longitudinally along the support deck of the dispensing system, showing the packaged products dispensed from the rear panel of the package;

FIGS. 6A and 6B show side and perspective views of a dispensing system according to another embodiment of the disclosure, illustrating the activatable opening structure of the package and an opening tab of the dispensing system capable of engaging with the activatable opening structure;

FIGS. 6C to 6D show side and perspective views of the dispensing system in FIG. 6A as the package is further moved longitudinally along the support deck of the dispensing system;

FIGS. 7A to 7D show side views of a dispensing system according to another embodiment of the disclosure, illustrating the engagement between the activatable opening structure of the package and the opening tool of the dispensing system that creates the opening on the rear corner of the package through which the products are dispensed from the package into the product display area of the dispensing system; and

FIG. 8 illustrates yet embodiment of the disclosed dispensing system, wherein the packaged products are dispensed from the front panel of the package into the product display area.

### DETAILED DESCRIPTION

Detailed descriptions of specific embodiments of the dispensing device apparatus and packages are disclosed herein. It will be understood that the disclosed embodiments are merely examples of the way in which certain aspects of the disclosure can be implemented and do not represent an exhaustive list of all of the ways the disclosure may be embodied. Indeed, it will be understood that the apparatus and packages described herein may be embodied in various and alternative forms. The figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the disclosure.

In a first aspect, the disclosed dispensing system may be configured as a front-loading dispensing system, wherein a package may be loaded onto the frame of the dispensing system by moving the package from the front of the frame toward the rear of the frame. As the package moves toward the rear of the frame, the opening tool of the dispensing system may engage the package to form an opening in the rear of the package, and products housed in the package may longitudinally move through the opening (at least partially) before dropping from the upper level to the lower level of the frame and, ultimately, moving to the product display area of the frame.

In one embodiment of the first aspect, a dispersing system for dispensing products provided initially in a package is disclosed, wherein the package includes a series of panels including opposed front and rear panels, opposed side panels, and opposed top and bottom panels, and an activatable opening structure on at least one of the panels, the dispensing system including:
(a) a frame being configured to support the package of products and including:
   (i) longitudinally opposed front and rear end sections, and
   (ii) a support deck extending at least partially between the from and rear end sections and below which a product display area is provided; and
(b) an opening tool associated with the frame, wherein the opening tool engages with the activatable opening structure on the package to create an opening when the package is moved longitudinally along the frame, thus allowing the products to be at least partially dispensed into the product display area of the frame through the opening formed at least in the rear panel of the package.

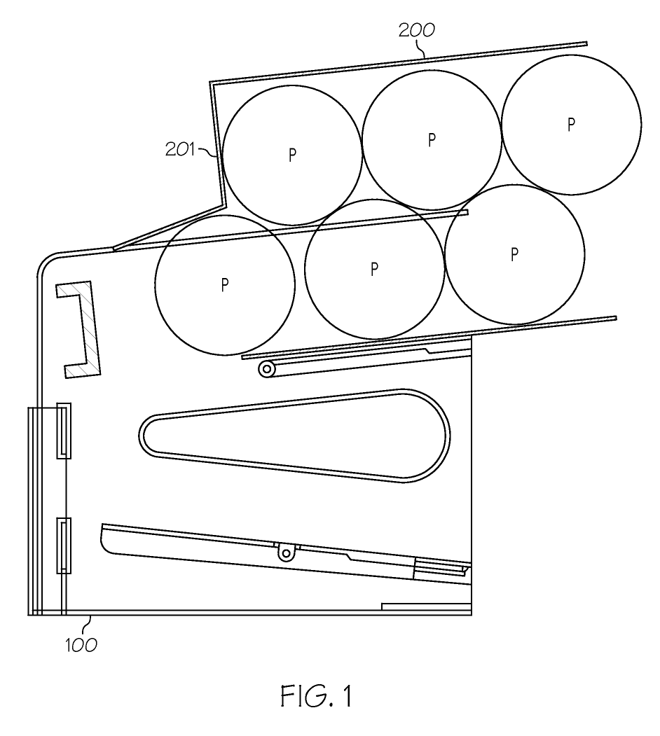

FIG. 1 shows one particular embodiment of the disclosed dispensing system. The dispensing system includes a frame 100 configured to support the package 200 housing products P, and an opening tool (not shown in FIG. 1) associated with the frame 100. The package 200 includes an activatable opening structure 201 on its rear panel. The opening tool engages the activatable opening structure 201 on the rear panel of the package to form an opening when the package is moved longitudinally along the frame, thereby allowing the products to be at least partially dispensed from the package, through the opening, and into the product display area.

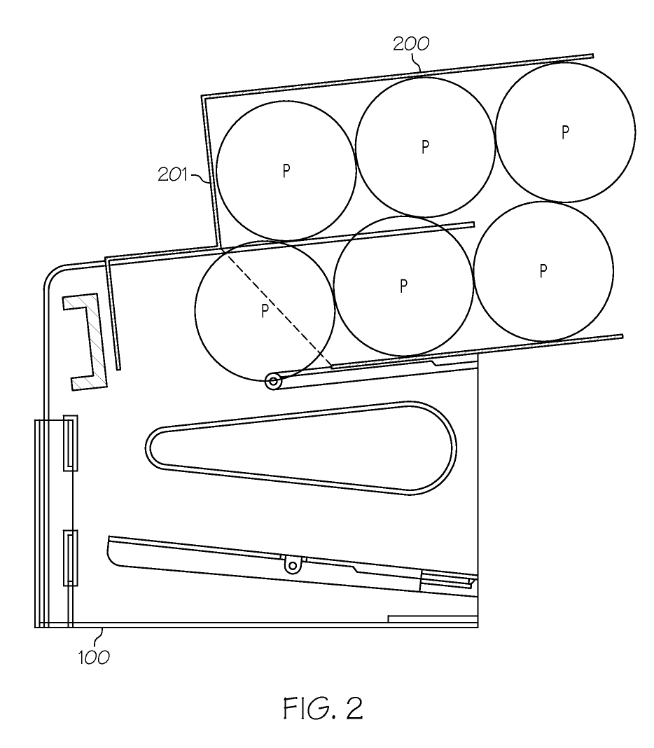

FIG. 2 shows another embodiment of the disclosed dispensing system. The dispensing system includes a frame 100 configured to support the package 200 housing products P, and an opening tool (not shown in FIG. 2) associated with the frame. The package 200 includes an activatable opening structure 201 such that once the package 200 is loaded onto the frame 100 and moved longitudinally along the frame, the activatable opening structure 201 on the package engages with the opening tool for form an opening in the package, thus allowing products P to be at least partially dispensed through the opening from an angular portion of the rear and side panels of the package into the product display area of the frame. When desired, the angular plane for the opening may be 45 degree between the rear and side panels of the package.

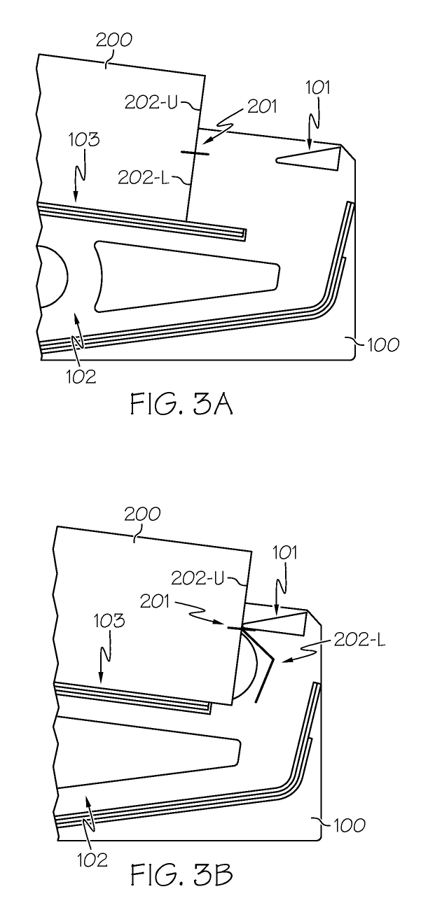

FIGS. 3A-3D illustrate the dispensing of products from a dispensing system according to another embodiment of the present disclosure. The dispersing system includes a frame 100 being configured to support the package 200 of products P and an opening tool 101. The frame includes longitudinally opposed front and rear end sections and arm upper support deck 103 extending at least partially between the front and rear end sections and below which a product display area 102 is provided. The package 200 includes an activatable opening structure 201 at its rear panel 202. The opening tool 101 on the frame 100 may be a protrusion, and the activatable opening structure 201 may be in the form of a crease, a frangible line or a weakened severance line at the rear panel 202 dividing the rear panel into the upper portion 202-U and the lower portion 202-L. As the package 200 is loaded onto the frame 100 and moved longitudinally towards the opening tool 101 (FIG. 3A), the opening tool 101 engages the activatable opening structure 201 on the rear panel 202 of the package and severs the weakened severance line such that the bottom portion 202-L of the rear panel is opened (FIG. 3B). Consequently, the products P are dispensed out of the package 200, through the opening (FIGS. 3C and 3D) between the upper and lower levels, and to the product display area 102 of the frame 100.

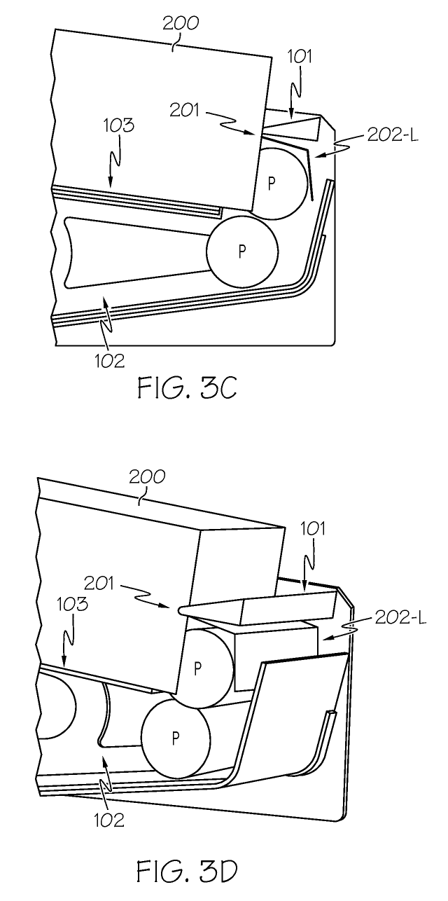

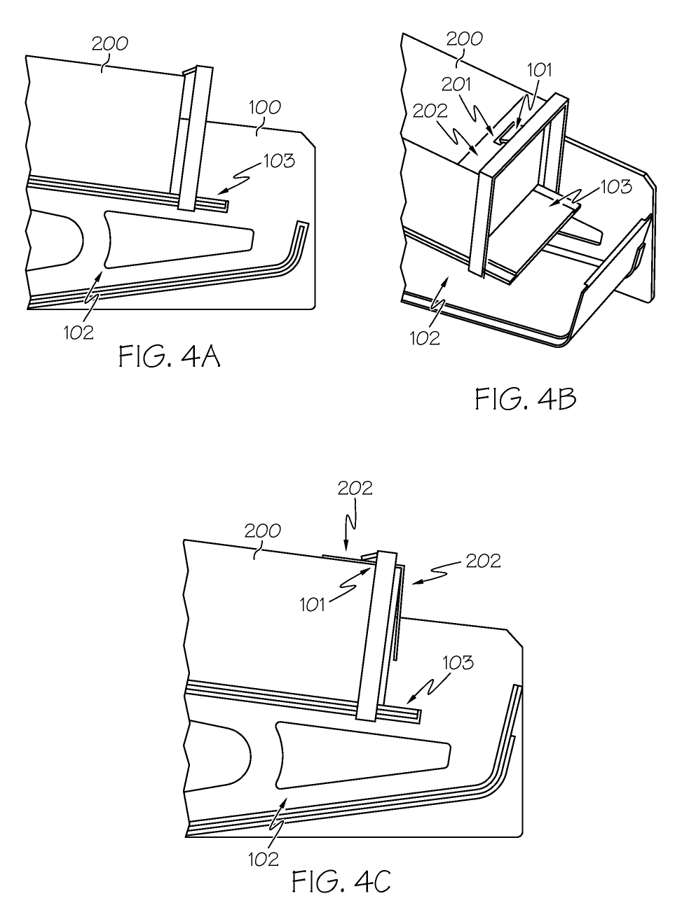

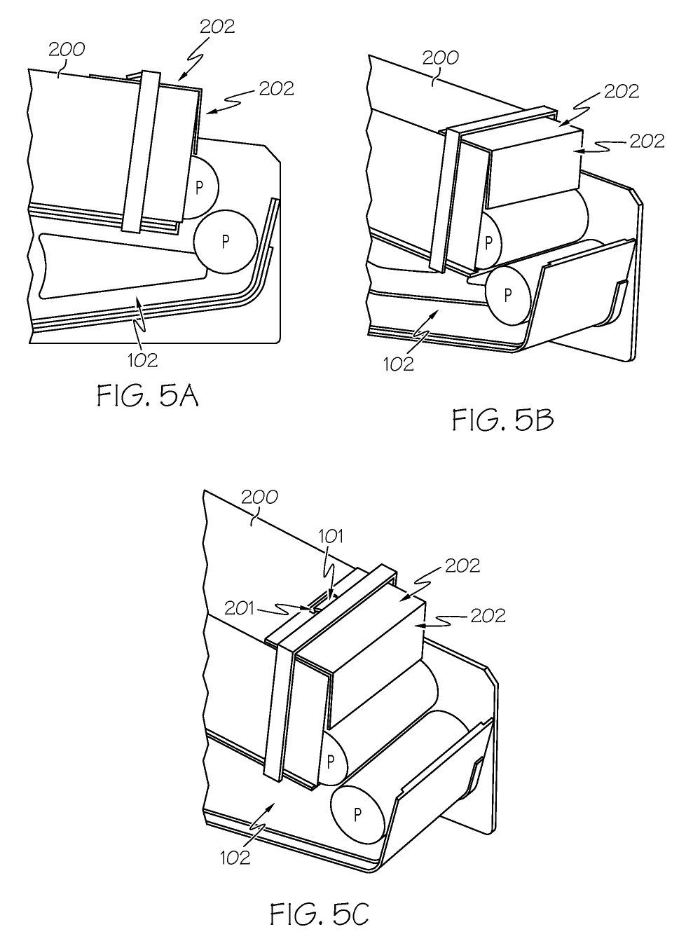

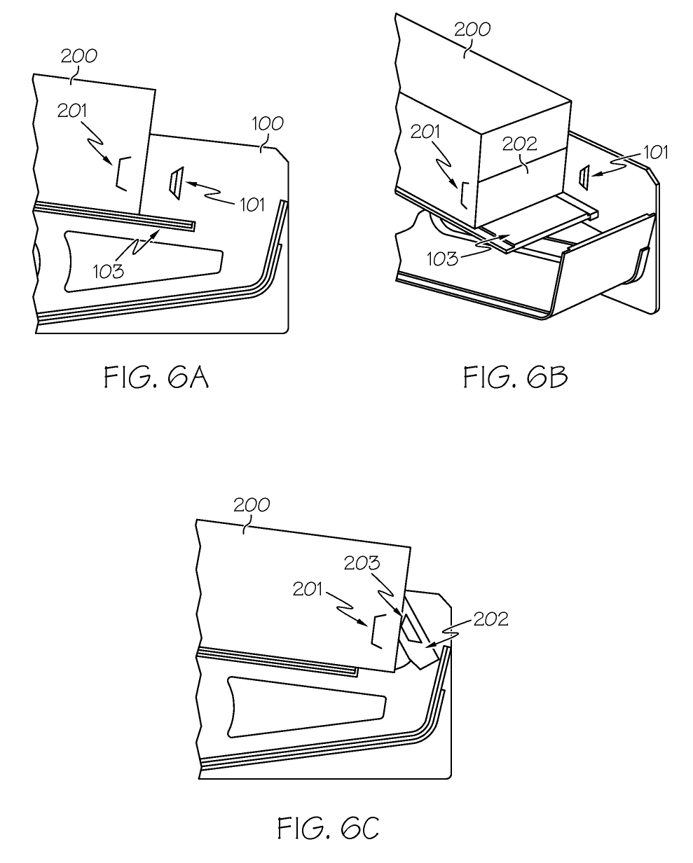

FIGS. 4A-4C and 5A-5C illustrate the dispensing of the products from the dispensing system according to another embodiment of the present disclosure. FIGS. 4A and 4B show a side view and a perspective view of such dispensing system respectively. The package 200 includes a series of panels including a rear panel 202, and an activatable opening structure 201. The frame 100 of the dispensing system includes an upper support deck 103 to support the package 200 once it is loaded onto the dispensing system, a product display area 102, and an opening tool 101 to engage with the activatable opening structure 201 on the package 200. When the package 200 is loaded onto the dispensing system and moved longitudinally on the upper support deck 103 towards the opening tool 101, the opening tool 101 engages with the activatable opening structure 201 on the package 200. Referring to FIG. 4C, as the package 200 is moved further along the upper support deck 103, the engagement between the opening tool 101 and activatable opening structure 201 causes at least a portion of the rear panel 202 to slid over onto the top panel of the package such that the opening is created at the rear end of the package. As shown in FIGS. 5A to 5C, the products P then may be dispensed through the opening at the rear end of the package onto the product display area 102 of the frame 100.

In one embodiment of the dispensing system shown in FIGS. 4A-4C and 5A-5C, the activatable opening structure may be a flap or aperture on the rear panel of the package. The opening tool on the dispensing system engages with the flap or aperture on the package upon loading the package into the dispensing system. As the package is further moved longitudinally along the upper support deck, the engagement between the opening tool and the flap or aperture causes the rear panel to slide upward, revealing the opening area for the products to dispense out of the package into the display area of the dispensing system.

When desired, the package suitable for use with the dispensing system of FIGS. 4A-4C may further include a removable tear strip on the rear panel of the package. The removable tear strip may be removed from the rear panel of the package prior to loading the package onto the dispensing system.

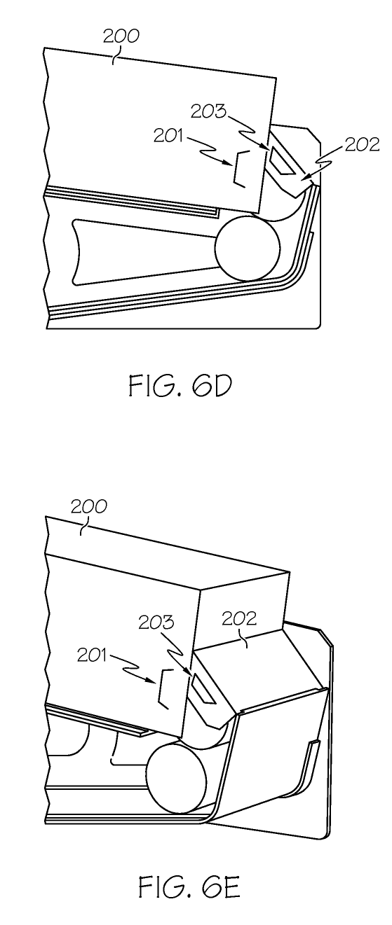

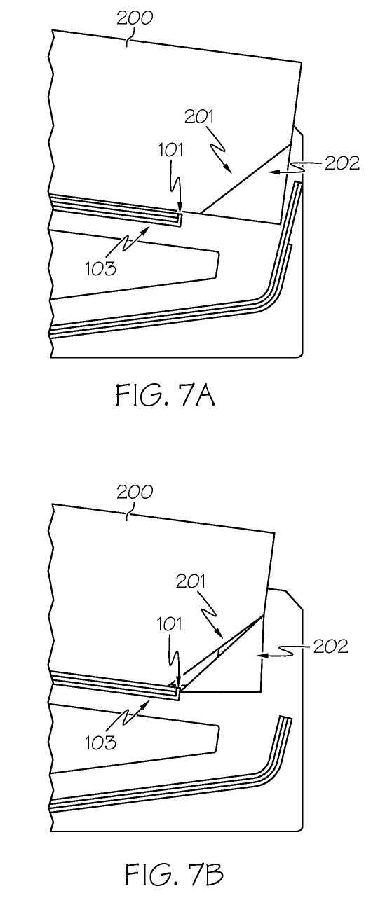

FIGS. 6A to 6E illustrate the dispensing of the products from the dispensing system according to another embodiment of the present disclosure. FIGS. 6A and 6B show side and perspective views of the disclosed dispensing system respectively. The package 200 may include a plurality of panels, including opposed side panels and a rear panel 202; an activatable opening structure 201 on each side panel; and a locking tab 203 (shown in FIG. 6C) releasably engaged with the activatable opening structure 201. The frame 100 of the dispensing system may include: an upper support deck 103 to support the package 200 once it is loaded onto the dispensing system; a product display area 102; and an opening tool 101 to engage with the activatable opening structure 201 on the package 200. When the package 200 is loaded onto the dispensing system and moved longitudinally on the upper support deck 103 towards the opening tool 101, the opening tool 101 engages with the activatable opening structure 201 on the package 200. In turn, the activatable opening structure 201 engages with the locking tab 203 to release at least a portion of the rear panel 202 such that an opening is created at the rear end of the package as shown in FIG. 6C. Consequently, the products P may be dispensed out of the package through the opening from the rear end of the package to the product display area of the dispensing system as shown in FIGS. 6D and 6E.

In one embodiment of the dispensing system shown in FIG. 6, the activatable opening structure on the package and the opening tool on the dispensing system may be in the form of reciprocal lock and release structures.

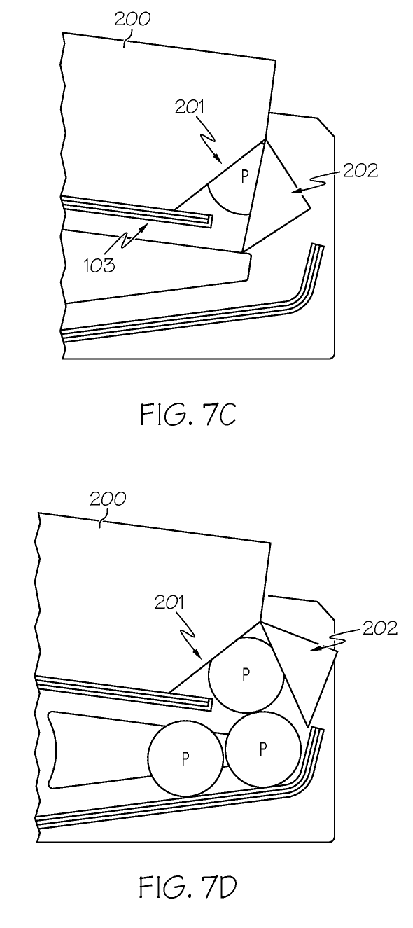

FIGS. 7A to 7D illustrate the dispensing of the products from the dispensing system according to another embodiment of the present disclosure, wherein the products are dispensed from the rear corner of the package through a “push in and pull back” motion.

FIG. 7A shows a side view of such dispensing system embodiment. The package 200 may include: a series of panels including a bottom panel and a rear panel 202; and an activatable opening structure 201 on the package panels. The frame 100 of the dispensing system may include: an upper support deck 103 to support the package 200 once it is loaded onto the dispensing system; a product display area; and an opening tool 101 to engage with the activatable opening structure 201 on the package 200. First, the package 200 is loaded onto the dispensing system by placing on the upper support deck 103 as shown in FIG. 7A. Then, the package 200 is moved longitudinally by “pulling forward” along the support deck 103 such that the opening tool 101 engages with the activatable opening structure 201 on the package 200 and the opening is created on the package as shown in FIG. 7B. Subsequently, the package 200 is “pushed back” along the support deck 103 (FIG. 7C) to enlarge the formed opening. As the package 200 is further “pushed back” along support deck 103 (FIG. 7D), the opening becomes bigger in size and allows the products to be dispensed out of the package through the opening into the product display area of the dispensing system. In one embodiment, the activatable opening structure may be a flap on the bottom panel of the package. In one embodiment, the activatable opening structure may be a crease, frangible or weaken line that is severable upon engaging with the opening tool on the dispensing system by a “push in and pull back” motion of the loaded package along the upper support deck.

It is to be understood that only some embodiments of the disclosed dispensing systems are shown. Other structures of the opening tools on the dispensing systems and/or the activatable opening structures on the package may be used in the present disclosure without departing from the scope of the present disclosure. These structures may be modified to accommodate the end use applications of the packages.

One skilled in the art will readily recognize that other shapes and sizes of the dispensing systems and the packages may be used. Additionally, the disclosed dispensing systems and/or the packages for use therewith may accommodate more than one product in different arrays.

In another embodiment of the disclosed dispensing system, the frame may further include a lower display deck associated with the product display area.

In another embodiment of the disclosed dispensing system, the frame may further include a rear wall configured to guide the products to the product display area.

In another embodiment of the disclosed dispensing system, the upper support deck may be inclined at an acute angle with respect to a horizontal plane.

In another embodiment of the disclosed dispensing system, the opening tool may be integrally connected to the frame.

In another embodiment of the disclosed dispensing system, the opening tool may be removably connected to the frame.

In another embodiment of the disclosed dispensing system, the frame may further include first and second laterally opposed side walls adapted and configured for guiding the package as it is moved longitudinally along the upper support deck.

In another embodiment of the disclosed dispensing system, the frame may further include a lane divider to create two display channels within the product display area.

In a second aspect, the disclosed dispensing system may be configured as a rear-loading dispensing system, wherein a package may be loaded onto the frame of the dispensing system by moving the package from the rear of the frame toward the front of the frame. As the package reaches the front of the frame, the opening tool of the dispensing system may engage the package to form an opening in the front of the package, and products housed in the package may longitudinally move through the opening (at least partially) before transitioning to the product display area of the frame.

A rear-loading dispenser is disclosed in U.S. Ser. No. 13/039,667 filed on Mar. 3, 2011, the entire contents of which are incorporated herein by reference.

The product display area of a rear-loading dispenser may be configured in various ways. The configuration of the product display area may depend on whether the frame includes a single support deck or multiple support decks (e.g., a lower support deck positioned below an upper support deck).

In one construction, the product display area may be positioned below the support deck. Therefore, product longitudinally moving through the opening in the front of the package may eventually drop below the support deck to the product display area.

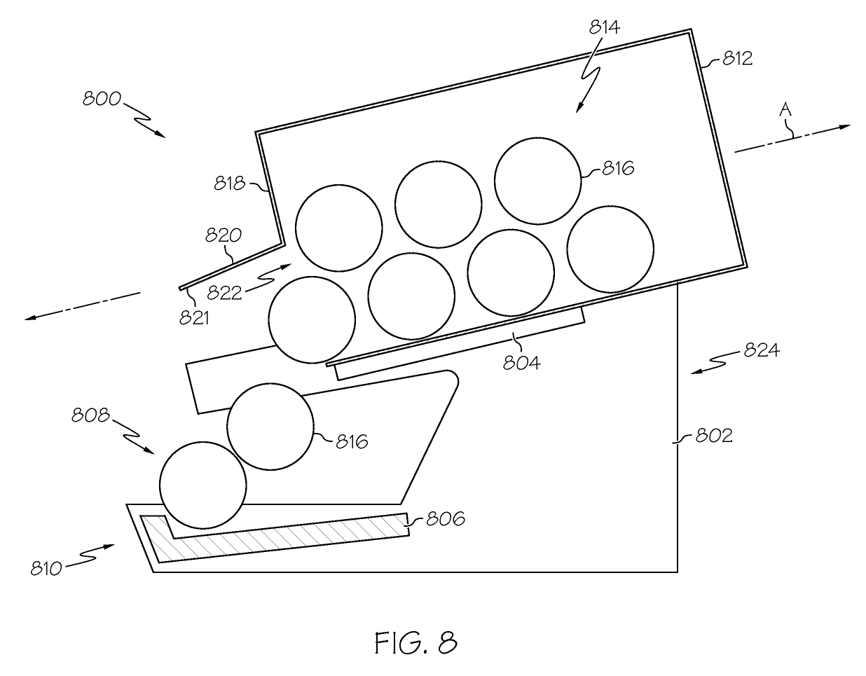

As shown in FIG. 8, the dispensing system 800 may include a frame 802 and an opening tool (not shown in FIG. 8) associated with the frame 802. The frame 802 may include an upper support deck 804 and a lower support deck 806, and the lower support deck 806 may define a product display area 808 proximate the front end section 810 of the frame 802. Those skilled in the art will appreciate that the opening tools described above may be adapted for use with dispensing system 800.

A package 812 comprised of a plurality of walls may define an internal volume 814, and may house a plurality of products 816 in the internal volume 814. The front wall 818 of the package 812 may define an activatable opening structure 820 that, when engaged by the opening tool, forms an opening 822 in the package 812.

Thus, the package 812 may be loaded onto the frame 802 by urging the package 812 along the upper support deck 804 from the rear end section 824 toward the front end section 810 of the frame 802 along the longitudinal, loading axis A. As the package longitudinally moves toward the front end section 810 of the frame 802, the opening tool associated with the frame 802 may engage the activatable opening structure 820 to form the opening 822. For example, as shown in FIG. 8, engagement between the opening tool and the activatable opening structure 820 may free a pivoting flap 821, and the force of products 816 moving into engagement with the flap 821 under the force of gravity may cause the flap 821 to swing outward from the package 812 such that the products may move through the opening 822.

As is shown in FIG. 8, products 816 exiting the package 812 may initially move along the longitudinal, loading axis A as they travel through the opening 822. Then, after a certain amount of longitudinal movement, the products 816 may vertically drop from the upper support deck 804 down to the lower support deck 806 and, ultimately, to the product display area 808.

In another construction, the product display area may be positioned in front of the opening in the package on the same level as the support deck. Therefore, product may longitudinally move from the package, through the opening, and directly to the product display area, without the need for the product to drop from the support deck to another level.

Accordingly, the disclosed dispensing system may form an opening in a package such that products move along the longitudinal axis of the frame as they pass through the opening. The opening may be either at the rear or the front of the package depending on whether the system is configured as a front-loading or rear-loading system, respectfully. Optionally, after longitudinally moving at least partially through the opening, the products may vertically drop down to the lower level of the frame as they move to the product display area.

While the disclosure has been described by reference to various specific embodiments, it should be understood that numerous changes may be made within the spirit and scope of the inventive concepts described. It is intended that the disclosure not be limited to the described embodiments, but will have full scope defined by the language of the following claims.

What is claimed is:

1. A system for dispensing products provided initially in a package, wherein the package comprises a plurality of panels and an activatable opening structure on at least one panel of the plurality of panels, the dispensing system comprising:
(a) a frame being configured to support the package of products and including:
(i) a first end section and a second end section, the first end section being opposed from the second end section along a longitudinal axis,
(ii) a support deck extending at least partially between the first end section and the second end section, and
(iii) a product display area; and
(b) an opening tool associated with the frame, the opening tool engaging the activatable opening structure on the package to create an opening when the package is moved longitudinally along the support deck, thus allowing at least one of the products to longitudinally move along the axis at least partially through the opening and, ultimately, to the product display area.

2. The system of claim 1, wherein the product display area is positioned proximate the first end section.

3. The system of claim 1, wherein the product display area is positioned below the support deck.

4. The system of claim 1, wherein the package comprises opposed from and rear panels, opposed side panels and opposed top and bottom panels, and wherein the opening is formed at least in the rear panel.

5. The system of claim 1, wherein the package comprises opposed front and rear panels, opposed side panels and opposed top and bottom panels, and wherein the opening is formed at least in the front panel.

6. The system of claim 1, wherein:
the opening tool includes a protrusion; and
the activatable opening structure includes at least one of a crease line, a frangible line, and a weakened line,
wherein, upon moving the package longitudinally towards the opening tool, the opening tool severs the line to create the opening on the package for dispensing the products.

7. The system of claim 1, wherein the opening tool on the frame and the activatable opening structure on the package include reciprocal lock and release structures, such that upon moving the package longitudinally towards the opening tool, the opening tool engages with the activatable opening structure and unlocks the locking structures to create the opening on the package.

8. The system of claim 1, wherein the package comprises opposed front and rear panels, opposed side panels and opposed top and bottom panels, and wherein:
the opening tool includes a grabbing feature; and
the activatable opening structure being grabbed by the opening tool upon moving the package longitudinally towards the opening tool such that at least a portion of the rear panel of the package is slide over onto the top panel, thus creating the opening for dispensing the products.

9. The system of claim 1, wherein the package comprises opposed front and rear panels, opposed side panels and opposed top and bottom panels, and wherein:
the activatable opening structure includes at least one of a flap, a crease line, a frangible line and a weakened line,
wherein after loading the package onto the dispensing system:
upon first pulling the package along the support deck toward the first end section, the activatable opening structure engages with the opening tool to create the opening, and then
upon pushing the package along the support deck toward the second end section, the products are dispensed out of the package through the opening and to the product display area.

10. The system of claim 9, wherein the activatable opening structure is on the bottom panel of the package.

11. The system of claim 1, further comprising the package containing products.

12. The system of claim 1, wherein the opening tool is integrally connected to the frame.

13. The system of claim 1, wherein the opening tool is removably connected to the frame.

14. A blank for forming a package, wherein the blank comprises:
(a) a plurality of panels including a rear panel, two opposing side panels, a top panel, a bottom panels and a front panel; and
(b) an activatable opening structure on at least one of the panels;
wherein, upon forming the blank into a package, tilling the package with products, and moving the package longitudinally along a dispensing system, the activatable opening structure engages with the dispensing system to create an opening through which the encased products are dispensed out of the package, the opening being formed at least in the rear panel of the package.

15. The blank of claim 14, wherein the blank further include a removable tear strip to be removed prior to moving the package along the dispensing system.

16. The blank of claim 14, derived from a material selected from a group consisting of paper-based material, paperboard, carton board, plastics, plastic-fiber composites, and combinations thereof.

17. A package derived from the blank of claim 14.

18. A method of dispensing products provided initially in a package, the method comprising steps of:
(1) providing a frame configured to support the package of products, the frame including:
(a) a first end section and a second end section, the first end section being opposed from the second end section along a longitudinal axis,
(b) a support deck extending at least partially between the first end section and the second end section, and
(c) a product display area;
(2) associating an opening tool with the frame;
(3) loading the package onto the frame, the package including:
(a) a plurality of panels; and
(b) an activatable opening structure on at least one panel of the plurality of panels; and
(4) moving the package longitudinally along the support deck such that the opening tool engages the activatable opening structure to form an opening, wherein at least one of the products longitudinally moves along the axis at least partially through the opening and, ultimately, to the product display area.

19. The method of claim 18, wherein the product display area is positioned below the support deck and proximate the first end section, and wherein the at least one product drops down to the product display area after longitudinally moving along the axis at least partially through the opening.

20. The method of claim 18, wherein the package comprises a front panel, a rear panel, a first side panel, a second side panel, a top panel and a bottom panel, the front panel being opposed from the rear panel, the first side panel being opposed from the second side panel and the top panel being opposed from the bottom panel, and wherein the opening is formed at least in the rear panel.

21. A dispensing system comprising:
(a) a frame including:
(i) a first end section and a second end section, the first end section being opposed from the second end section along a longitudinal axis,
(ii) a support deck extending at least partially between the first end section and the second end section, the support deck defining an upper level, a lower level and an opening between the upper level and the lower level, wherein the opening is positioned proximate the second end section, and
(iii) a product display area positioned in the lower level proximate the first end section; and
(b) an opening tool connected to the frame, wherein the opening tool is positioned in the upper level at least partially over the opening, and wherein the opening tool is vertically displaced from the support deck.

22. The dispensing system of claim 21, wherein the frame further includes lateral opposed side walls.

23. The dispensing system of claim 22, wherein the opening tool laterally extends between the side walls.

24. The dispensing system of claim 21, wherein the vertical displacement of the opening tool relative to the support deck is sufficient to allow a product to move between the opening tool and the support deck.

25. The dispensing system of claim 21, wherein the opening tool is wedge-shaped.
